(19) United States
(12) Patent Application Publication
(10) Pub. No.: US 2026/0104349 A1
(43) Pub. Date: Apr. 16, 2026

(54) SYSTEM AND METHOD FOR UPSTREAM PURGING IN INSPECTION SYSTEMS

(71) Applicant: KLA Corporation, Milpitas, CA (US)

(72) Inventors: Yihua Hao, Milpitas, CA (US); Guoheng Zhao, Palo Alto, CA (US); Chunhai Wang, Pleasanton, CA (US)

(21) Appl. No.: 19/275,162

(22) Filed: Jul. 21, 2025

Related U.S. Application Data
(60) Provisional application No. 63/707,211, filed on Oct. 15, 2024.

(51) Int. Cl. G01N 21/15; G01N 21/956

(52) U.S. Cl. CPC G01N 21/15; G01N 21/956; G01N 2021/151

(57) ABSTRACT

An inspection system may include an objective lens housing, where the objective lens housing is configured to house an objective lens. The inspection system may include a purging sub-system configured to deliver a gas to a sample as the sample is scanned. The purging sub-system may include a gas source configured to provide the gas, one or more flow valves, one or more flow controllers, an upstream purging channel within the objective lens housing of the objective lens, and an upstream purging outlet connected to the upstream purging channel and configured to purge the gas. The upstream purging outlet may be positioned upstream from a scan direction of the sample, such that as the sample is scanned, the gas is moved towards a field of view of the objective lens.

### CROSS-REFERENCE TO RELATED APPLICATIONS

The present application claims the benefit under 35 U.S.C. § 119(e) of U.S. Provisional Application No. 63/707,211, filed Oct. 15, 2024, which is herein incorporated by reference in the entirety.

### TECHNICAL FIELD

The present disclosure relates generally to inspection systems and, more particularly, to a system and method for upstream purging in inspection systems.

### BACKGROUND

In semiconductor inspection systems reducing noise is necessary to improve defect detection sensitivity. Noise sources of unpatterned wafer inspection may include wafer surface scattering (e.g., haze), sensor noise, and air scattering. Wafer haze may be suppressed using polarization masks and sensor noise may be suppressed through design and process improvements. Background noise from air scattering, caused by light interacting with gas molecules, significantly affects inspection sensitivity.

Existing techniques to reduce air scattering include enclosing the inspection system in a vacuum chamber. However, these vacuum-based systems have a number of disadvantages. For example, the vacuum-based systems require all mechanical, optical, and electronic components to be vacuum-compatible, which causes problems with cooling, cleanliness, and inspection speed, while also significantly increasing cost and engineering difficulty. By way of another example, the vacuum-based systems demand ultra-high vacuum pump rates (e.g., on the order of 10,000 liters per minute) which are impractical for compact, high-speed inspection tools and can cause vibration and turbulence issues. Further, the pressure differential between the vacuum inspection area and atmospheric conditions can cause wafer deformation and degrade detection sensitivity.

An additional existing technique includes using a direct purging method, where helium is purged directly into the inspection area through the objective illumination channel. However, such method was designed for a spot scanning system where there is a large mechanical clearance and gas turbulence is not a concern. In such systems it is difficult to achieve high helium purity with the large open boundary. Further, the local purging method requires the auto-focus and illumination outlet port of the objective to be sealed. Sealing the illumination port of the objective is especially difficult due to laser damaging the sealing of the glass window. To achieve 5% air concentration, the gas flow rate needs to be greater than 4 L/min, which increases costs.

Therefore, it is desirable to provide systems and methods for curing the above deficiencies.

### SUMMARY

An inspection system is disclosed, in accordance with one or more embodiments of the present disclosure. In embodiments, the inspection system includes an objective lens housing, where the objective lens housing is configured to house an objective lens. In embodiments, the inspection system includes a purging sub-system configured to deliver a gas to a sample as the sample is scanned. In embodiments, the purging sub-system includes a gas source configured to provide the gas. In embodiments, the purging sub-system includes one or more flow valves. In embodiments, the purging sub-system includes one or more flow controllers. In embodiments, the purging sub-system includes an upstream purging channel within the objective lens housing of the objective lens. In embodiments, the purging sub-system includes an upstream purging outlet connected to the upstream purging channel and configured to purge the gas, where the upstream purging outlet is positioned upstream from a scan direction of the sample, where as the sample is scanned, the gas is moved towards a field of view (FOV) of the objective lens.

An inspection system is disclosed, in accordance with one or more embodiments of the present disclosure. In embodiments, the inspection system includes an objective lens housing, where the objective lens housing is configured to house an objective lens. In embodiments, the inspection system includes a motion sub-system configured to scan a sample along a scan direction, where the motion sub-system includes a linear stage to translate the sample along the scan direction, where one or more illumination optics direct one or more illumination beams to the sample as the sample is scanned by the linear stage, and a rotation spindle, where the linear stage is configured to linearly translate the rotation spindle during inspection. In embodiments, the inspection system includes a purging sub-system configured to deliver a gas to the sample as the sample is scanned. In embodiments, the purging sub-system includes a gas source configured to provide the gas. In embodiments, the purging sub-system includes one or more flow valves. In embodiments, the purging sub-system includes one or more flow controllers. In embodiments, the purging sub-system includes an upstream purging channel within the objective lens housing of the objective lens. In embodiments, the purging sub-system includes an upstream purging outlet connected to the upstream purging channel and configured to purge the gas, where the upstream purging outlet is positioned upstream from the scan direction of the sample, where as the sample is scanned by the motion sub-system, the gas is moved towards a field of view (FOV) of the objective lens. In embodiments, the purging sub-system includes an edge purging module including an edge purging outlet, where the edge purging module is configured to provide an additional stream of the gas to the sample when the FOV of the objective lens is at an edge of the sample. In embodiments, the inspection system includes a computer sub-system communicatively coupled to the motion sub-system and the purging sub-system, the computer sub-system including one or more processors configured to execute program instructions causing the one or more processors to: generate a first set of control signals configured to cause the gas source to provide the gas to the upstream purging channel and the edge purging module; generate a second set control signals configured to cause the edge purging module to stop distributing the gas upon the sample being translated a predetermined distance by the motion sub-system; and generate a third set of signals configured to cause the upstream purging channel to stop distributing the gas upon the sample being fully scanned by the motion sub-system.

An inspection system is disclosed, in accordance with one or more embodiments of the present disclosure. In embodiments, the inspection system includes a computer sub-system communicatively including one or more processors configured to execute program instructions causing the one or more processors to: generate a first set of control signals configured to cause a gas source to provide a gas to an upstream purging channel within an objective lens housing and an edge purging module; generate a second set control signals configured to cause the edge purging module to stop distributing the gas upon a sample being translated a predetermined distance by a motion sub-system; generate a third set of signals configured to cause the upstream purging channel to stop distributing the gas upon the sample being fully scanned by the motion sub-system; generate one or more images of the sample based on light detected by a collection sub-system; and identify one or more sample defects on the sample based on the one or more images of the sample.

A method is disclosed, in accordance with one or more embodiments of the present disclosure. In embodiments, the method includes positioning an edge of a sample at a field of view (FOV) of an objective lens by adjusting a location of a linear stage. In embodiments, the method includes providing a gas from a gas source to an upstream purging channel and an edge purging module, where the upstream purging channel purges a stream of the gas to the sample via an upstream purging outlet, where the edge purging module purges an additional stream of the gas to the sample via an edge purging outlet. In embodiments, the method includes illuminating a sample with one or more illumination beams generated by an illumination source. In embodiments, the method includes scanning the sample. In embodiments, the method includes stopping the edge purging module from distributing the additional stream of the gas upon the sample being scanned a predetermined distance. In embodiments, the method includes stopping the upstream purging channel from distributing the stream of the gas from the upstream purging outlet upon completion of the sample being scanned. In embodiments, the method includes collecting light illuminated from the sample. In embodiments, the method includes generating one or more images of the sample based on the light collected from the sample. In embodiments, the method includes identifying one or more sample defects on the sample based on the one or more images generated.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

### BRIEF DESCRIPTION OF DRAWINGS

The numerous advantages of the disclosure may be better understood by those skilled in the art by reference to the accompanying figures in which:

FIG. 1A illustrates a conceptual view of an inspection system, in accordance with one or more embodiments of the present disclosure.

FIG. 1B illustrates a schematic view of an inspection sub-system of the inspection system, in accordance with one or more embodiments of the present disclosure.

FIG. 2A illustrates a schematic bottom view of an objective lens housing of the inspection sub-system, in accordance with one or more embodiments of the present disclosure.

FIG. 2B illustrates a cross-sectional view of the objective lens housing of the inspection sub-system, in accordance with one or more embodiments of the present disclosure.

FIG. 3A illustrates a conceptual bottom view of the objective lens housing, in accordance with one or more embodiments of the present disclosure.

FIG. 3B illustrates a conceptual bottom view of the objective lens housing, in accordance with one or more embodiments of the present disclosure.

FIG. 4A illustrates a schematic view of a purging sub-system of the inspection sub-system, in accordance with one or more embodiments of the present disclosure.

FIG. 4B illustrates a schematic view of the purging sub-system, in accordance with one or more embodiments of the present disclosure.

FIG. 5 illustrates a flow diagram illustrating steps performed in a method for performing inspection, in accordance with one or more embodiments of the present disclosure.

FIG. 6 illustrates a helium concentration plot, in accordance with one or more embodiments of the present disclosure.

### DETAILED DESCRIPTION

Reference will now be made in detail to the subject matter disclosed, which is illustrated in the accompanying drawings. The present disclosure has been particularly shown and described with respect to certain embodiments and specific features thereof. The embodiments set forth herein are taken to be illustrative rather than limiting. It should be readily apparent to those of ordinary skill in the art that various changes and modifications in form and detail may be made without departing from the spirit and scope of the disclosure.

In semiconductor inspection systems reducing noise is necessary to improve defect detection sensitivity. Noise sources of unpatterned wafer inspection may include wafer surface scattering (e.g., haze), sensor noise, and air scattering. Wafer haze can be suppressed by polarization masks. As sensor noise continues to decrease through design and process improvements, the background noise caused by air scattering has a great impact on the inspection sensitivity. For example, scattering from gas molecules may be shown and described by Equation 1 below:

$${S}_{air} ∼ \frac{{l ( n - 1 )}^{2}}{{λ}^{4} N} \qquad Equation 1$$

Where l is the light path length, n is the refractive index of gas, N is the number of gas molecule density. N may be related to pressure P and temperature T, as shown and described by Equation 2 below:

$$N = \frac{P}{kT} \qquad Equation 2$$

Where k is Boltzmann constant. The refractive index of gas may be proportional to pressure P, as shown and described by Equation 3 below:

$$n - 1 ∝ P \qquad Equation 3$$

Therefore, air scattering is linear to pressure and quadric to refractive index. As such, air scattering may be reduced using low-pressure (e.g., vacuum pressure) or gas (e.g., helium gas). However, existing methods to reduce air scattering with vacuum pressure or helium purging have drawbacks, such as limited mechanical clearance, degraded image quality, insufficiently clean environments, extremely high vacuum pump rate, high gas flow rate, inability to achieve high helium purity, and the like. There is therefore a need for an upstream purging method and system configured to reduce air scattering and enhance the defect sensitivity.

Embodiments of the present disclosure are directed to a system and method for upstream purging in inspection systems. For example, the system and method may be configured to rotate and/or translate the sample and use such motion to move the gas to the inspection field of view (FOV). For instance, the purging port may be integrated with the objective lens housing, where the purging hole may be positioned upstream from the FOV of the objective lens. In this regard, purging efficiency is improved and the consumption of gas is reduced.

It is contemplated herein that the system and method of the present disclosure may provide a number of advantages over the prior art. For example, there the illumination port and auto-focus port does not need to be sealed as is required with the direct purging method discussed previously. By way of another example, there is no need for an ultra-high speed vacuum pump or sealing the inspection system in a vacuum chamber as required by previous methods. Further, the system and method of the present disclosure decreases gas consumption, allows for simpler implementation, and is compatible with a high numerical aperture (NA) imaging objective lens.

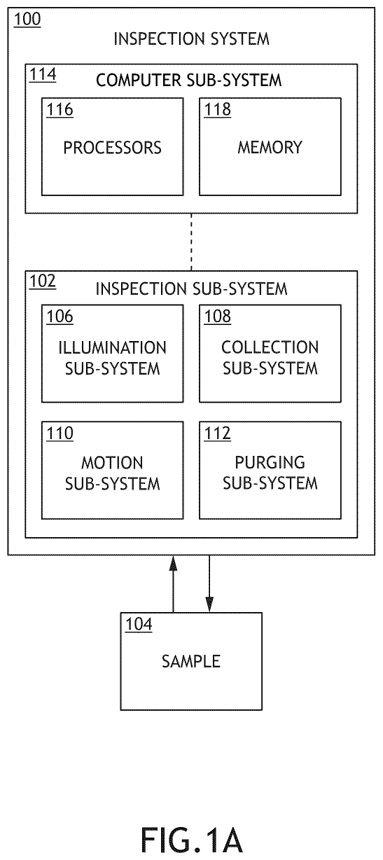

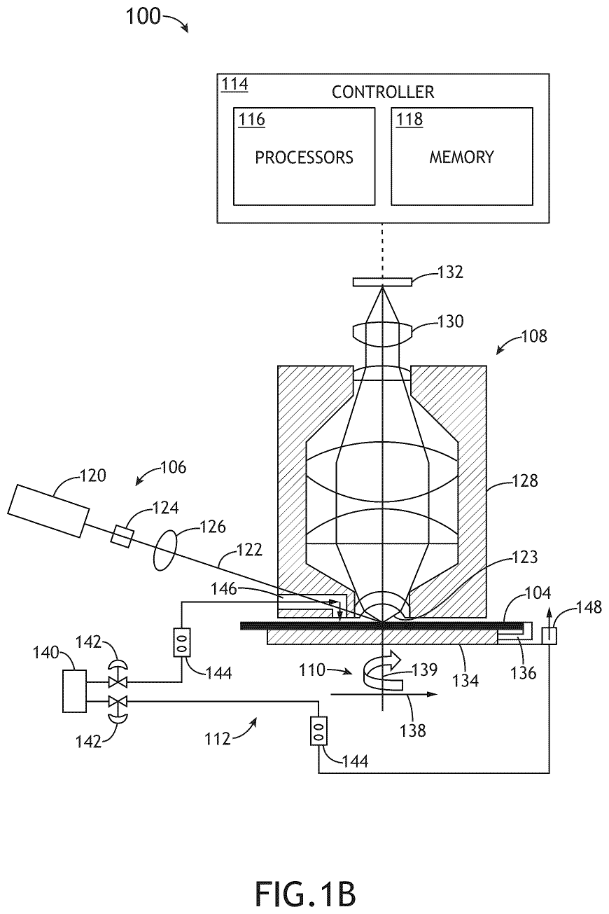

Referring now to FIGS. 1A-6, a system and method for upstream purging in inspection systems, are described in greater detail in accordance with one or more embodiments of the present disclosure.

FIG. 1A is a conceptual view of an inspection system 100 for performing defect detection, in accordance with one or more embodiments of the present disclosure.

In embodiments, the inspection system 100 includes an inspection sub-system 102 to perform inspection (e.g., defect detection) of a sample 104. For example, the inspection sub-system may include an optical imaging based inspection sub-system configured to generate one or more images of the sample 104, where the inspection sub-system may be configurable to image the sample 104.

In embodiments, the inspection sub-system 102 includes an illumination sub-system 106, a collection sub-system 108, a motion sub-system 110, and a purging sub-system 112. For example, the illumination sub-system 106 may be configured to illuminate the sample 104 and the collection sub-system 108 may be configured to collect signals emanated from the sample 104 in response to light emanating from the sample 104.

The purging sub-system 112 may be configured to deliver a gas to the sample 104 as the sample is scanned by the motion sub-system 110. For example, as will be discussed further herein, the gas may be purged using the purging sub-system 112 to a purging channel on the objective housing of the collection sub-system 108. In this regard, a purging outlet of the purging channel may be arranged upstream the inspection area of the sample 104, where the sample 104 is scanned by the motion sub-system 110 and such scanning motion moves the gas to the inspection FOV.

In embodiments, the system 100 includes a computer sub-system 114. The computer sub-system 114 includes one or more processors 116 and memory 118. The one or more processors 116 may be configured to execute a set of program instructions maintained in the memory 118. For example, the one or more processors 116 may be configured to receive one or more images from the collection sub-system 108 as the sample 104 is scanned along a stage-scan direction by the motion sub-system 110 when implementing an inspection recipe. By way of another example, the one or more processors 116 may be configured to detect one or more defects on the sample 104 based on the received one or more images. By way of another example, the one or more processors 116 may be configured to cause the purging sub-system 112 to start and/or stop the gas from being distributed through the purging outlet.

FIG. 1B is a schematic view of the inspection sub-system 102, in accordance with one or more embodiments of the present disclosure.

In embodiments, the illumination sub-system 106 is configured to generate illumination, via an illumination source 120, in the form of one or more illumination beams 122 to illuminate the sample 104 and the collection sub-system 108 is configured to collect light 123 from the illuminated sample 104.

The illumination sub-system 106 is configured to direct the one or more illumination beams 122 generated by the illumination source 120 to the sample 104 at one or more angles of incidence. For example, as shown in FIG. 1B, the one or more illumination beams 122 from the illumination source 120 may be directed at an oblique angle of incidence through an optical element 124 and lens 126 to a detection area of the sample 104.

The light 123 from the illuminated sample 104 is configured to be directed through an objective lens 128 and an optical element 130, where the light 123 is collected by a detector 132.

The sample 104 may be disposed on a vacuum chuck 134. For example, the vacuum chuck 134 may be configured to hold the sample 104 using vacuum pressure. An edge handling chuck 136 may further hold the sample 104 by a sample edge. In this regard, the sample 104 may be supported by pressured air having a specified vacuum preload.

Edge handling chucks are generally discussed in U.S. Pat. No. 6,702,302, issued Mar. 9, 2004, which is herein incorporated by reference in the entirety.

In embodiments, the motion sub-system 110 includes a linear stage 138 configured to spirally scan the sample 104 through the inspection FOV of the inspection sub-system 102 during a measurement to implement scanning inspection. For example, the linear stage 138 may scan the sample 104 during rotation of the edge handling chuck 136 and the sample, where the linear stage 138 is configured to linearly translate a spindle 139 during inspection. The motion sub-system 110 may include any number of linear actuators, rotational actuators, or angle actuators to position the sample 104 using any number of degrees of freedom.

In embodiments, the purging sub-system 112 includes a gas source 140 configured to provide the gas to the inspection sub-system 102. The gas source 140 may include any type of gas such as, but not limited to, helium, nitrogen, argon, or the like.

The gas may be purged through one or more control valves 142 and one or more flow controllers 144.

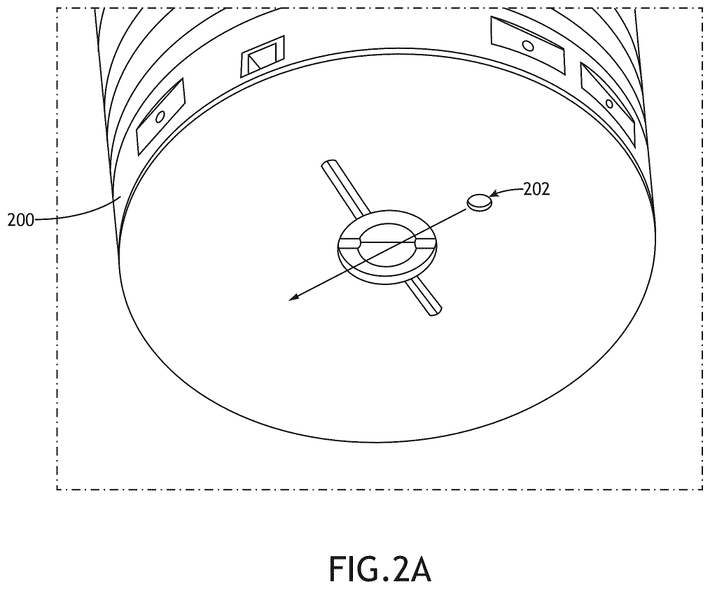

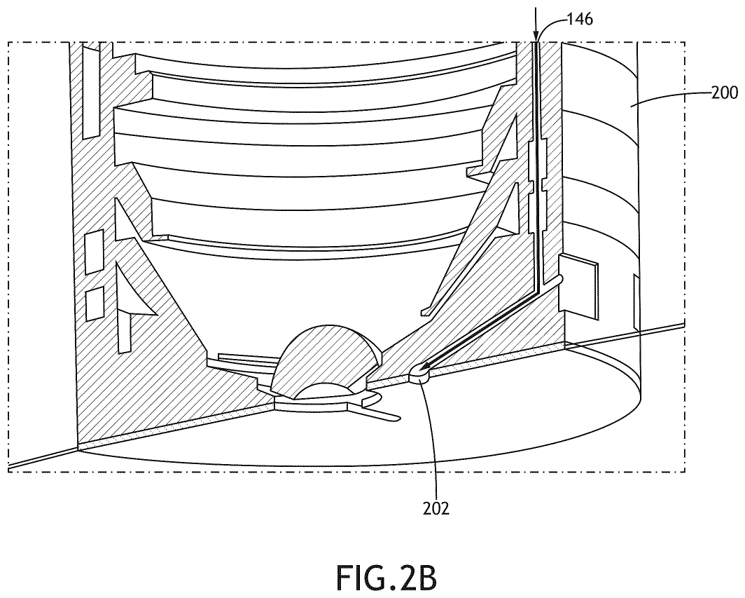

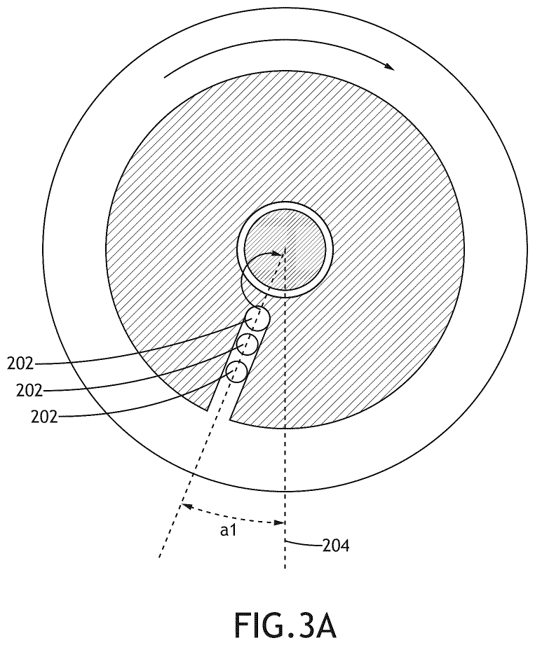

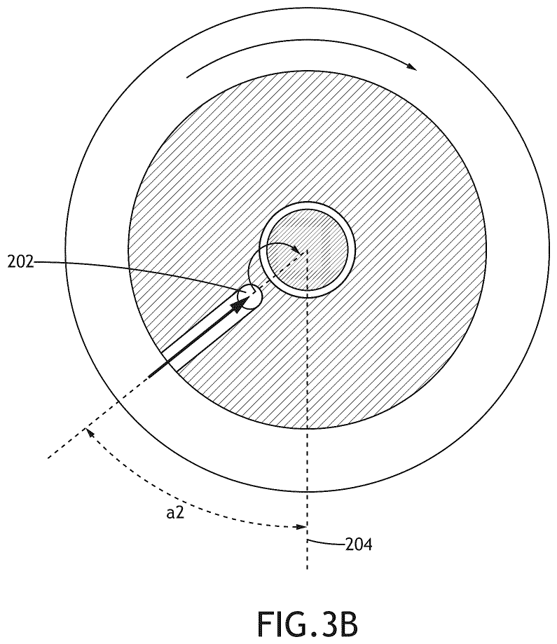

FIGS. 2A-2B illustrate an objective lens housing 200 including the objective lens 128, in accordance with one or more embodiments of the present disclosure. FIGS. 3A-3B illustrate top views of the objective lens housing 200, in accordance with one or more embodiments of the present disclosure. In embodiments, the gas is purged though an upstream purging channel 146 in the objective lens housing 200.

In embodiments, the objective lens housing 200 includes an upstream purging hole 202 (or outlet) fluidly coupled to the upstream purging channel 146. For example, the gas provided by the gas source 140 may travel through the one or more control valves 142 and the one or more flow controllers 144 to the upstream purging channel 146 inside the objective lens housing 200, where the gas may be purged through the upstream purging hole 202.

It is contemplated herein that the position of the upstream purging hole 202 impacts the final air concentration. For example, as shown in FIG. 3A, an axial distance between the upstream purging hole 202 and the FOV of the objective may be adjusted. In some instances, the objective housing 200 may include a plurality of upstream purging holes 202 having independent flow rates. In this regard, the flow rates may be adjusted based on the scanning radius. In additional instances, the objective housing 200 may include a plurality of upstream purging holes 202, where one or more auto-rotating disks may be coupled to the bottom of the objective housing 200 to cover purging ports that are not being used. In this regard, a specified purging port may be used to distribute the gas and the remaining purging ports may be covered via a respective auto-rotating disk. By way of another example, as shown in FIGS. 3A-3B, an angle between the upstream purging hole 202 and a scanning direction 204 may be adjusted. In one instance, as shown in FIG. 3A, the upstream purging hole 202 may be arranged at an angle a1 with respect to the scanning direction 204. In another instance, as shown in FIG. 3B, the upstream purging hole 202 may be arranged at an angle a2 with respect to the scanning direction 204.

It is noted herein that the distance and/or angle shown in FIGS. 3A-3B are provided merely for illustrative purposes and shall not be construed as limiting the scope of the present disclosure. For example, in a non-limiting example, the upstream purging hole 202 may be between approximately 10 mm and 30 mm from the FOV of the objective lens 128. For instance, the upstream purging hole 202 may be approximately 20 mm from the FOV of the objective lens 128. By way of another example, in a non-limiting example, the upstream purging hole 202 may have an angle between approximately 0-20 degrees from a scanning tangential direction 204 of the sample 104.

The upstream purging hole 202 may have a diameter between approximately 4 mm and 10 mm. For example, in a non-limiting example, the diameter of the upstream purging hole 202 may be approximately 6 mm.

The distance between the bottom of the objective housing 200 to a top surface of the sample 104 may be between 0.1 mm and 1.5 mm. For example, in a non-limiting example, the distance between the bottom of the objective housing 200 and the top surface of the sample 104 may be approximately 0.5 mm.

In embodiments, the purging sub-system 112 further includes an edge purging module 148 configured to provide an additional stream of the gas when the FOV of the objective lens 128 is at an edge of the sample 104. For example, the edge purging module 148 may be coupled to the motion sub-system 110. For instance, the edge purging module 148 may be coupled to the spindle 139, such that the edge purging module 148 moves with the linear stage 138.

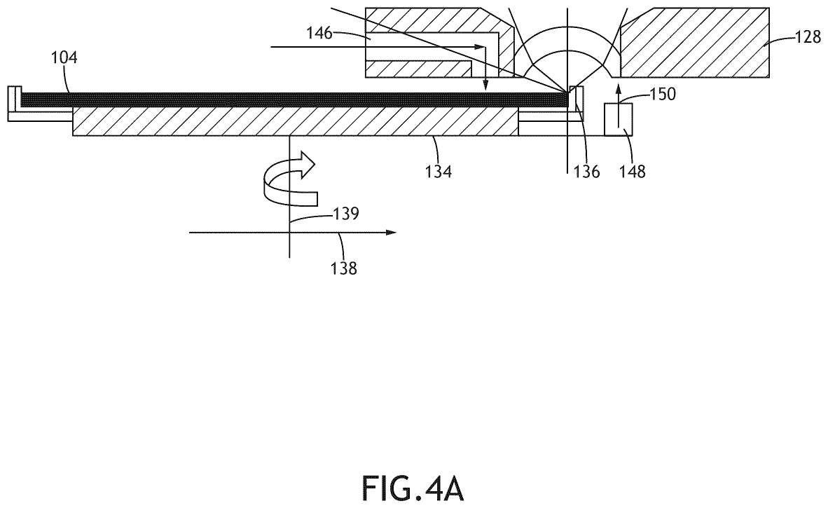

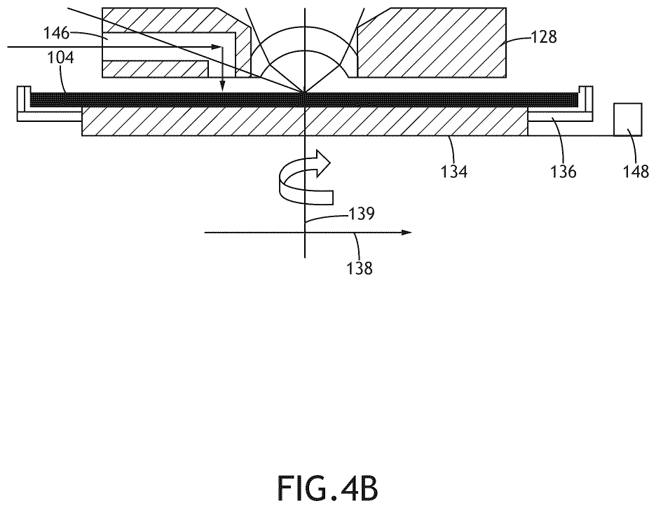

FIGS. 4A-4B illustrate the purging sub-system 112 including the edge purging module 148, in accordance with one or more embodiments of the present disclosure. For example, as shown in FIGS. 4A-4B, the edge purging module 148 may be configured to provide an initial purging at an edge of the sample 104 via an edge purging port 150. It is contemplated herein that edge purging via the edge purging module 148 may ensure that air concentration is at a specified concentration at the start of scanning at the sample edge. For example, in a non-limiting example, edging purging at 2 L/min may reduce the air concentration to less than 5% at the start of scanning at the sample edge.

The lateral position of the edge purging module 148 may be adjusted based on one or more parameters of the vacuum chuck 134 and/or edge handling chuck 136. However, it is contemplated herein that that edge purging module 148 may be arranged such that it is approximately 5 mm to 30 mm away from the edge of the sample 104. Further, the top surface of the purging module 148 may be arranged such that it is roughly the sample height as the sample surface.

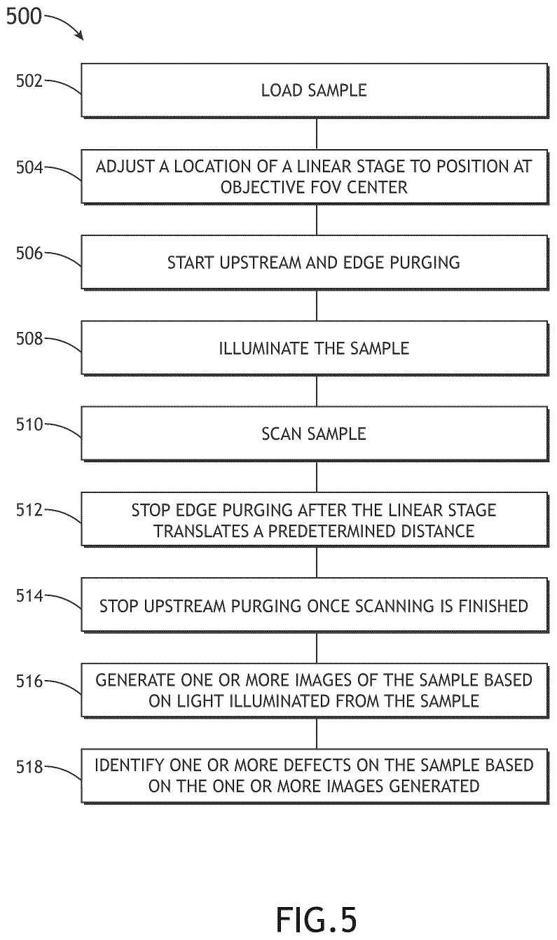

FIG. 5 is a flow diagram illustrating steps performed in a method 500 for performing scanning inspection of the sample 104, in accordance with one or more embodiments of the present disclosure. Applicant notes that the embodiments and enabling technologies described previously herein in the context of the overlay metrology system 100 should be interpreted to extend to the method 500. It is further noted, however, that the method 500 is not limited to the architecture of the overlay metrology system 100.

In a step 502, the sample may be loaded onto the vacuum chuck and the edge handling chuck. For example, the sample 104 may be disposed on the vacuum chuck 134 and the edge handling chuck 136 may hold the edge of the sample 104.

In a step 504, a location of the linear stage may be adjusted such that the edge of the sample is positioned at an objective FOV center. For example, the linear stage 138 may translate the sample 104 until the edge of the sample 104 is positioned at the objective FOV center (as shown in FIG. 4B).

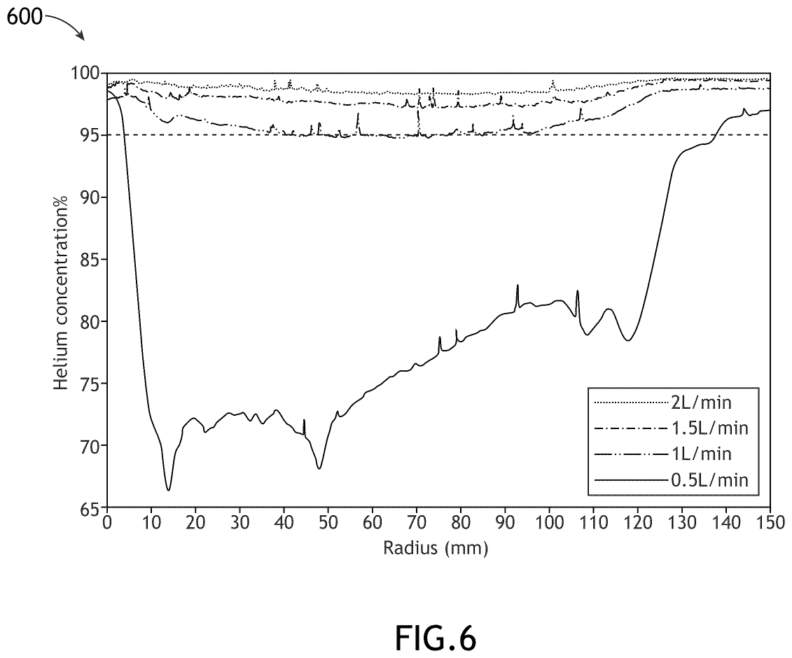

In a step 506, upstream purging and edge purging may be started. For example, the one or more processors 116 may be configured to generate one or more control signals configured to cause the gas source 140 to begin providing the gas to the upstream purging channel 146 and the edge purging module 148. It is contemplated herein that the upstream purging flow rate may be constant (e.g., at approximately 1 L/min) or may be variable based on the stage rotation and motion speed to minimize gas consumption. Further, it is contemplated herein that the edge purging module 148 may have a constant flow rate of approximately 2 L/min when it is on. Referring to FIG. 6, FIG. 6 depicts a plot 600 illustrating helium purging rates. As shown in the plot 600 of FIG. 6, a purge rate of 1 L/min achieves a 5% air concentration level (helium concentration 95%), where combining such purging with edge purging, the final helium flow rate may be approximately 1.3 L/min. A flow rate below 1 L/min provides an insufficient level of air concentration/helium concentration.

In a step 508, the sample may be illuminated. For example, the illumination source 120 of the illumination sub-system 106 may be configured to generate the one or more illumination beams 122, where the optical element 124 and the lens 126 may direct the one or more illumination beams 122 to the detection area of the sample 104.

In a step 510, the sample may be scanned. For example, the one or more processors 116 may be configured to generate one or more control signals configured to cause the motion sub-system 110 to begin scanning the sample 104. For instance, the linear stage 138 may begin translating the sample 104 along the x-axis. In this regard, as the sample 104 is scanned, the gas from the upstream purging hole 202 may be moved towards the center of the FOV of the sample, where an air concentration may be reduced thereby minimizing air scattering and background noise.

In a step 512, the edge purging may be stopped after the linear stage moves a predetermined distance. For example, the edge purging module 148 may stop distributing the gas after the linear stage 138 has moved the predetermined distance. For instance, once the linear stage 138 moves the predetermined distance, the one or more processors 116 may be configured to generate one or more control signals configured to cause the one or more flow controllers 144 (or the one or more flow valves 142) to stop distributing the gas to the edge purging module 148. It is contemplated herein that the predetermined stage distance may be between 5-30 mm. For example, in a non-limiting example, after the linear stage 138 moves approximately 15 mm along the x-axis, the edge purging module 148 may stop purging.

It is contemplated herein that the edge purging module 148 may also be stopped after a predetermined amount of time has elapsed. Therefore, the above discussion shall not be construed as limiting the scope of the present disclosure.

In a step 514, the upstream purging may be stopped once the sample has been fully scanned. For example, after scanning has finished, the one or more processors 116 may be configured to generate one or more control signals configured to cause the gas source 140 to stop providing the gas (e.g., turn off the gas source 140) (or cause the valves 142 and/or flow controllers 144 to stop providing the gas to the channel 146).

In a step 516, one or more images of the sample may be generated. For example, the one or more processors 116 may receive one or more images of the sample based on light collected via the detector 132 of the collection sub-system 108.

In a step 518, one or more defects on the sample may be identified based on the one or more images.

Referring again to FIG. 1B, additional components of the inspection sub-system 102 are described in greater detail in accordance with one or more embodiments of the present disclosure.

The sample 104 may include any type of sample suitable for inspection. For example, the sample 104 may include a substrate. The substrate may include a wafer. For example, the sample 104 may include a bare unpatterned wafer. Further, the sample 104 may include a meta-lens, a reticle, a mask, or the like.

The illumination 122 from the illumination source 120 may include one or more selected wavelengths of light including, but not limited to, ultraviolet (UV) radiation, visible radiation, or infrared (IR) radiation.

The illumination source 120 may include any type of illumination source suitable for providing at least one illumination beam 122. In embodiments, the illumination source 120 is a laser source. For example, the illumination source 120 may include, but is not limited to, one or more narrowband laser sources, a broadband laser source, a supercontinuum laser source, a white light laser source, or the like. In this regard, the illumination source 120 may provide an illumination beam 122 having high coherence (e.g., high spatial coherence and/or temporal coherence). In embodiments, the illumination source 120 includes a laser-sustained plasma (LSP) source. For example, the illumination source 120 may include, but is not limited to, an LSP lamp, an LSP bulb, or an LSP chamber suitable for containing one or more elements that, when excited by a laser source into a plasma state, may emit broadband illumination.

In embodiments, the illumination sub-system 106 includes one or more optical components suitable for modifying and/or conditioning the illumination beam 122 as well as directing the illumination beam 122 to the sample 104. For example, the illumination sub-system 106 may include one or more illumination lenses 126 (e.g., to collimate the illumination beam 122, or the like). In embodiments, the illumination sub-system 106 includes one or more illumination control optics 124 to shape or otherwise control the illumination beam 122. For example, the illumination control optics 124 may include, but are not limited to, one or more apodizers, one or more field stops, one or more pupil stops, one or more polarizers, one or more filters, one or more beam splitters, one or more diffusers, one or more homogenizers, one or more beam shapers, or one or more mirrors (e.g., static mirrors, translatable mirrors, scanning mirrors, or the like).

In embodiments, the collection sub-system 108 includes one or more optical elements suitable for modifying and/or conditioning the collected light 123 from the sample 104. In embodiments, the collection sub-system 108 includes one or more collection lenses (e.g., to collimate the illumination beam 122, to relay pupil and/or field planes, or the like), which may include, but are not required to include, the objective lens 128. In embodiments, the collection sub-system 108 includes one or more collection control optics to shape or otherwise control the collected light 123. For example, the collection control optics may include, but are not limited to, one or more field stops, one or more pupil stops, one or more polarizers, one or more filters, one or more beam splitters, one or more diffusers, one or more homogenizers, one or more apodizers, one or more beam shapers, or one or more mirrors (e.g., static mirrors, translatable mirrors, scanning mirrors, or the like).

The detector 132 may include any type of sensor suitable for measuring sample light. For example, the detector 132 may include, but is not limited to, a charge-couple device (CCD), a complementary metal-oxide-semiconductor (CMOS) device, a time-delay-integration (TDI) sensor, a photomultiplier tube (PMT), or the like.

The herein described subject matter sometimes illustrates different components contained within, or connected with, other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected” or “coupled” to each other to achieve the desired functionality, and any two components capable of being so associated can also be viewed as being “couplable” to each other to achieve the desired functionality. Specific examples of couplable include but are not limited to physically interactable and/or physically interacting components and/or wirelessly interactable and/or wirelessly interacting components and/or logically interactable and/or logically interacting components.

It is believed that the present disclosure and many of its attendant advantages will be understood by the foregoing description, and it will be apparent that various changes may be made in the form, construction, and arrangement of the components without departing from the disclosed subject matter or without sacrificing all of its material advantages. The form described is merely explanatory, and it is the intention of the following claims to encompass and include such changes. Furthermore, it is to be understood that the invention is defined by the appended claims.

What is claimed:

1. An inspection system comprising:
an objective lens housing, wherein the objective lens housing is configured to house an objective lens; and
a purging sub-system configured to deliver a gas to a sample as the sample is scanned, wherein the purging sub-system comprises:
a gas source configured to provide the gas;
one or more flow valves;
one or more flow controllers;
an upstream purging channel within the objective lens housing of the objective lens; and
an upstream purging outlet connected to the upstream purging channel and configured to purge the gas, wherein the upstream purging outlet is positioned upstream from a scan direction of the sample,
wherein as the sample is scanned, the gas is moved towards a field of view (FOV) of the objective lens.

2. The inspection system of claim 1, further comprising:
a motion sub-system configured to scan the sample along the scan direction, wherein the motion sub-system comprises:
a linear stage to translate the sample along the scan direction; and
a rotation spindle, wherein the linear stage is configured to linearly translate the rotation spindle during inspection.

3. The inspection system of claim 2, wherein the sample is disposed on a vacuum chuck and an edge of the sample is held by an edge handling chuck.

4. The inspection system of claim 2, wherein the purging sub-system further comprises:
an edge purging module including an edge purging outlet, wherein the edge purging module is configured to provide an additional stream of the gas to the sample when the FOV of the objective lens is at an edge of the sample.

5. The inspection system of claim 4, further comprising a computer sub-system communicatively coupled to the motion sub-system and the purging sub-system, wherein the computer sub-system includes one or more processors configured to execute program instructions causing the one or more processors to:
generate a first set of control signals configured to cause the gas source to provide the gas to the upstream purging channel and the edge purging module;
generate a second set control signals configured to cause the edge purging module to stop distributing the gas upon the sample being translated a predetermined distance by the motion sub-system; and
generate a third set of signals configured to cause the upstream purging channel to stop distributing the gas upon the sample being fully scanned by the motion sub-system.

6. The inspection system of claim 5, wherein the predetermined distance is 15 mm.

7. The inspection system of claim 1, wherein the upstream purging outlet has a diameter between 4 mm and 10 mm.

8. The inspection system of claim 7, wherein the diameter of the upstream purging outlet is 6 mm.

9. The inspection system of claim 1, wherein the upstream purging outlet is positioned between 10 mm and 30 mm from the FOV of the objective lens.

10. The inspection system of claim 9, wherein the upstream purging outlet is positioned 20 mm from the FOV of the objective lens.

11. The inspection system of claim 1, wherein an angle between the upstream purging outlet and a scanning tangential direction of the sample is between 0 degrees and 20 degrees.

12. The inspection system of claim 1, wherein a distance between a bottom of the objective lens housing and a top surface of the sample is between 0.1 mm and 1.5 mm.

13. The inspection system of claim 12, wherein the distance between the bottom of the objective lens housing and the top surface of the sample is 0.5 mm.

14. The inspection system of claim 1, wherein the gas comprises at least one of:
helium gas or argon gas.

15. The inspection system of claim 1, wherein the sample comprises a wafer.

16. The inspection system of claim 15, wherein the wafer includes a bare unpatterned wafer.

17. The inspection system of claim 1, further comprising:
an illumination sub-system, wherein the illumination sub-system comprises comprising:
an illumination source configured to generate one or more illumination beams; and
one or more illumination optics configured to direct the one or more illumination beams to a detection area on the sample as the sample is scanned relative to the one or more illumination beams along the scan direction when implementing an inspection recipe.

18. The inspection system of claim 1, further comprising:
a collection sub-system, wherein the collection sub-system comprises:
a detector configured to detect light illuminated from the sample; and
one or more collection optics configured to direct the light illuminated from the sample to the detector, wherein the one or more collection optics include the objective lens.

19. An inspection system comprising:
an objective lens housing, wherein the objective lens housing is configured to house an objective lens;
a motion sub-system configured to scan a sample along a scan direction, wherein the motion sub-system comprises:
a linear stage to translate the sample along the scan direction, wherein one or more illumination optics direct one or more illumination beams to the sample as the sample is scanned by the linear stage; and
a rotation spindle, wherein the linear stage is configured to linearly translate the rotation spindle during inspection;
a purging sub-system configured to deliver a gas to the sample as the sample is scanned, wherein the purging sub-system comprises:
a gas source configured to provide the gas;
one or more flow valves;
one or more flow controllers;
an upstream purging channel within the objective lens housing of the objective lens;
an upstream purging outlet connected to the upstream purging channel and configured to purge the gas, wherein the upstream purging outlet is positioned upstream from the scan direction of the sample, wherein as the sample is scanned by the motion sub-system, the gas is moved towards a field of view (FOV) of the objective lens; and
an edge purging module including an edge purging outlet, wherein the edge purging module is configured to provide an additional stream of the gas to the sample when the FOV of the objective lens is at an edge of the sample; and
a computer sub-system communicatively coupled to the motion sub-system, and the purging sub-system, the computer sub-system including one or more processors configured to execute program instructions causing the one or more processors to:
generate a first set of control signals configured to cause the gas source to provide the gas to the upstream purging channel and the edge purging module;
generate a second set control signals configured to cause the edge purging module to stop distributing the gas upon the sample being translated a predetermined distance by the motion sub-system; and
generate a third set of signals configured to cause the upstream purging channel to stop distributing the gas upon the sample being fully scanned by the motion sub-system.

20. The inspection system of claim 19, wherein the sample is disposed on a vacuum chuck and the edge of the sample is held by an edge handling chuck.

21. The inspection system of claim 19, wherein the predetermined distance is 15 mm.

22. The inspection system of claim 19, wherein the upstream purging outlet has a diameter between 4 mm and 10 mm.

23. The inspection system of claim 22, wherein the diameter of the upstream purging outlet is 6 mm.

24. The inspection system of claim 19, wherein the upstream purging outlet is positioned between 10 mm and 30 mm from the FOV of the objective lens.

25. The inspection system of claim 24, wherein the upstream purging outlet is positioned 20 mm from the FOV of the objective lens.

26. The inspection system of claim 19, wherein an angle between the upstream purging outlet and a scanning tangential direction of the sample is between 0 degrees and 20 degrees.

27. The inspection system of claim 19, wherein a distance between a bottom of the objective lens housing and a top surface of the sample is between 0.1 mm and 1.5 mm.

28. The inspection system of claim 27, wherein the distance between the bottom of the objective lens housing and the top surface of the sample is 0.5 mm.

29. The inspection system of claim 19, wherein the gas comprises at least one of:
helium gas or argon gas.

30. The inspection system of claim 19, wherein the sample comprises a wafer.

31. The inspection system of claim 30, wherein the wafer includes a bare unpatterned wafer.

32. The inspection system of claim 19, further comprising:
an illumination sub-system, wherein the illumination sub-system comprises comprising:
an illumination source configured to generate the one or more illumination beams; and
one or more illumination optics configured to direct the one or more illumination beams to a detection area on the sample as the sample is scanned relative to the one or more illumination beams along the scan direction when implementing an inspection recipe.

33. The inspection system of claim 19, further comprising:
a collection sub-system, wherein the collection sub-system comprises:
a detector configured to detect light illuminated from the sample; and
one or more collection optics configured to direct the light illuminated from the sample to the detector, wherein the one or more collection optics include the objective lens.

34. The inspection system of claim 33, wherein the computer sub-system is communicatively coupled to the collection sub-system, wherein one or more processors are further configured to:
generate one or more images of the sample based on the light detected by the detector; and
identify one or more sample defects on the sample based on the one or more images of the sample.

35. An inspection system comprising:
a computer sub-system communicatively including one or more processors configured to execute program instructions causing the one or more processors to:
generate a first set of control signals configured to cause a gas source to provide a gas to an upstream purging channel within an objective lens housing and an edge purging module;
generate a second set control signals configured to cause the edge purging module to stop distributing the gas upon a sample being translated a predetermined distance by a motion sub-system;
generate a third set of signals configured to cause the upstream purging channel to stop distributing the gas upon the sample being fully scanned by the motion sub-system;
generate one or more images of the sample based on light detected by a collection sub-system; and
identify one or more sample defects on the sample based on the one or more images of the sample.

36. A method comprising:
positioning an edge of a sample at a field of view (FOV) of an objective lens by adjusting a location of a linear stage;
providing a gas from a gas source to an upstream purging channel and an edge purging module, wherein the upstream purging channel purges a stream of the gas to the sample via an upstream purging outlet, wherein the edge purging module purges an additional stream of the gas to the sample via an edge purging outlet;
illuminating a sample with one or more illumination beams generated by an illumination source;
scanning the sample;
stopping the edge purging module from distributing the additional stream of the gas upon the sample being scanned a predetermined distance;
stopping the upstream purging channel from distributing the stream of the gas from the upstream purging outlet upon completion of the sample being scanned;
collecting light illuminated from the sample;
generate one or more images of the sample based on the light collected from the sample; and
identify one or more sample defects on the sample based on the one or more images generated.
